(19) United States
(12) Patent Application Publication
(10) Pub. No.: US 2011/0033657 A1
(43) Pub. Date: Feb. 10, 2011

(54) METAL SHELL MANUFACTURING STRUCTURE AND METHOD

(76) Inventor: MAO-LIEN HUANG, Xinzhuang City (TW)

Correspondence Address: KILE PARK GOEKJIAN REED & MCMANUS, 1200 NEW HAMPSHIRE AVE, NW, SUITE 570, WASHINGTON, DC, 20036, US

(21) Appl. No.: 12/538,166

(22) Filed: Aug. 10, 2009

(51) Int. Cl. B32B 3/10; B23P 11/00

(52) U.S. Cl. 428/138; 29/428; 29/525.01

(57) ABSTRACT

The present invention discloses a metal shell manufacturing structure and method. The structure includes a metal substrate, at least one fixing groove, at least one plastic layer, and at least one assembling hole. The fixing groove is formed in the metal substrate and extends into the metal substrate from a surface of the metal substrate. The plastic layer is disposed on the metal substrate and fastened in the fixing groove. The assembling hole is formed in the plastic layer and extends into the plastic layer from a surface of the plastic layer. The formed plastic layer is fastened in the fixing groove directly and the plastic layer and the assembling hole can be formed in one piece via a mold, thereby simplifying the manufacturing process, reducing the costs and saving time. The present invention further discloses a metal shell manufacturing method.

### BACKGROUND OF THE INVENTION

1. Field of the Invention

The present invention relates to a metal shell manufacturing structure and method, and more particularly to a metal shell manufacturing structure and method which can manufacture metal shells so that various components are disposed on metal surfaces.

2. Description of Related Art

With the development of science and technology, various electronic products and electronic equipments occur. Metal manufacture is generally applied in these electronic products and electronic equipments, including external shell assembly and internal mechanism arrangement. Especially, internal mechanisms always have many functional components mounted therein, and the functional components need to be securely disposed in metal shells by metal manufacturing. Taking notebook computers for example, hardware, such as motherboards, hard disks, power supplies and so on, are mounted and fixed in metal shells.

As shown in FIG. 1A and FIG. 1B, a conventional manufacturing method includes: cutting a low positioning hole 2a in a surface of a metal substrate 1a, positioning an assembling pole 3a according with the size of the positioning hole 2a in the positioning hole 2a, and fixedly welding the assembling pole 3a in the positioning hole 2a by welding. At this time, a welding block 5a is connected with a bottom of the assembling pole 3a and an outer edge of the positioning hole 2a. A functional component 7a desired to be mounted is assembled in an assembling hole 4a (as shown in FIG. 2A and FIG. 2B) formed in the assembling pole 3a by a screw 6a, thereby completing the assembly.

However, the above-mentioned manufacturing method is very complicated: the size of the positioning hole 2a must be very accurately defined, and each positioning hole 2a needs to be cut separately and each assembling pole 3a needs to be positioned and welded separately. The same steps must be repeated on each position. So the more the components desired to be mounted are, the more the repeated steps are, which causes that the operation time is prolonged, the probability of failure is high, and the costs are quite high.

### SUMMARY OF THE INVENTION

A main object of the present invention is to provide a metal shell manufacturing structure and method which can simplify the metal shell manufacturing process and dispose various components on metal surfaces in a simple process, thereby reducing the costs and saving time.

To achieve the above-mentioned object, a metal shell manufacturing structure in accordance with the present invention is provided. The metal shell manufacturing structure includes: a metal substrate; at least one fixing groove formed in the metal substrate and extending into the metal substrate from a surface of the metal substrate; at least one plastic layer disposed on the metal substrate and fastened in the fixing groove; and at least one assembling hole formed in the plastic layer and extending into the plastic layer from a surface of the plastic layer.

To achieve the above-mentioned object, a metal shell manufacturing method in accordance with the present invention is provided. The metal shell manufacturing method includes the steps of:

(1). providing a metal substrate;

(2). forming at least one fixing groove in a position desired to be manufactured of the metal substrate, the fixing groove extending into the metal substrate from a surface of the metal substrate;

(3). forming a bottom board and at least one side board on the metal substrate, the side board located on a periphery of the bottom board; and

(4). disposing at least one plastic layer on the metal substrate, the plastic layer fastened in the fixing groove and fixed on the metal substrate; and forming at least one assembling hole in the plastic layer, the assembling hole extending into the plastic layer from a surface of the plastic layer.

In the metal shell manufacturing structure and method of the present invention, the formed plastic layers are fastened in the fixing grooves directly and the plastic layers and the assembling holes can be formed in one piece via a mold, so there is no need for cutting a hole separately and welding the assembling poles like prior arts, thereby simplifying the manufacturing process, reducing the costs, saving time and maximizing the efficiency for manufacturing metal shells.

### BRIEF DESCRIPTION OF THE DRAWINGS

FIG. 1A is a first top view of a prior art;

FIG. 1B is a first cross-sectional view of the prior art;

FIG. 2A is a second top view of the prior art;

FIG. 2B is a second cross-sectional view of the prior art;

FIG. 3A is a first top view of a metal shell manufacturing structure of the present invention;

FIG. 3B is a partially enlarged top view of part A in FIG. 3A;

FIG. 3C is a partially enlarged cross-sectional side view of part A in FIG. 3A;

FIG. 4A is a second top view of the metal shell manufacturing structure of the present invention;

FIG. 4B is a partially enlarged top view of part B in FIG. 4A;

FIG. 4C is a partially enlarged cross-sectional side view of part B in FIG. 4A;

FIG. 5A is a third top view of the metal shell manufacturing structure of the present invention;

FIG. 5B is a partially enlarged top view of part C in FIG. 5A;

FIG. 5C is a partially enlarged cross-sectional side view of part C in FIG. 5A;

FIG. 6A is a fourth top view of the metal shell manufacturing structure of the present invention;

FIG. 6B is a partially enlarged top view of part D in FIG. 6A;

FIG. 6C is a partially enlarged cross-sectional side view of part D in FIG. 6A; and

FIG. 7 is a flow chart of a metal shell manufacturing method of the present invention.

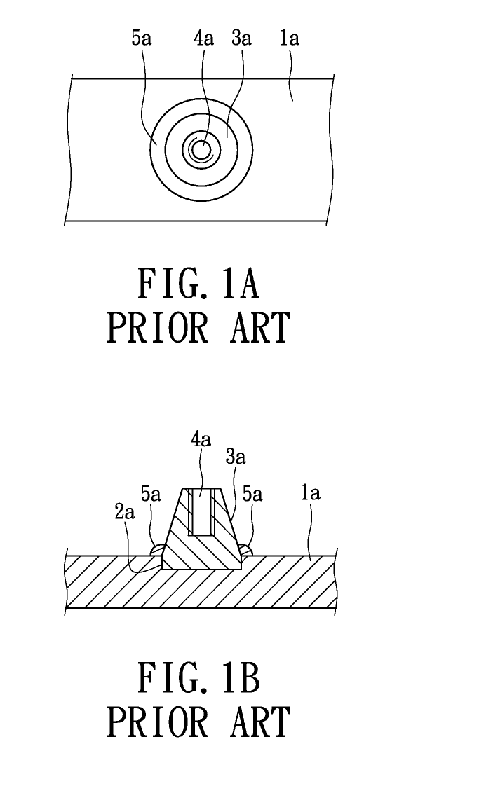

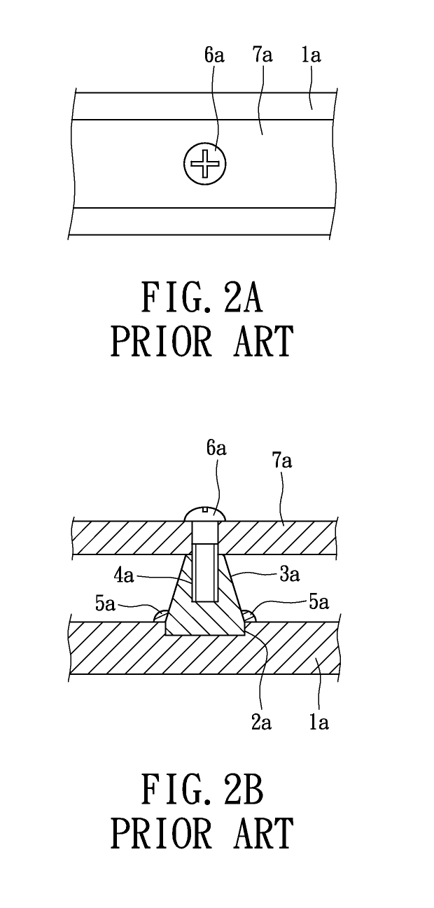

### DETAILED DESCRIPTION OF THE PREFERRED EMBODIMENTS

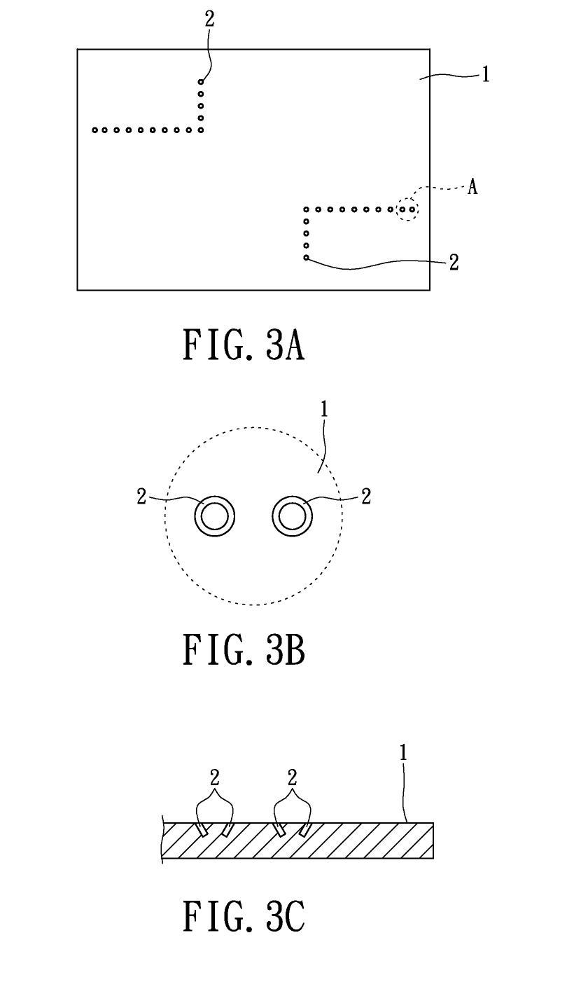

Please refer to FIGS. 3A-3C, FIGS. 4A-4C, FIGS. 5A-5C and FIGS. 6A-6C, illustrating a metal shell manufacturing structure according to the present invention. The metal shell manufacturing structure includes a metal substrate 1, at least one fixing groove 2, at least one plastic layer 3 and at least one assembling hole 4. The fixing grooves 2 are formed in the metal substrate 1, the plastic layers 3 are disposed on the metal substrate 1, the plastic layers 3 are fastened in the fixing grooves 2, and the assembling holes 4 are formed in the plastic layers 3.

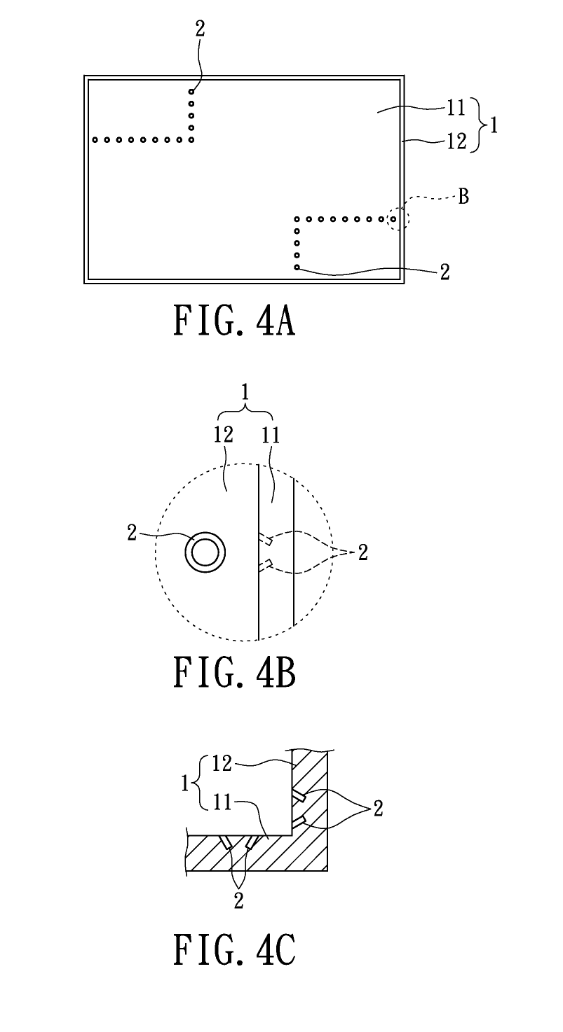

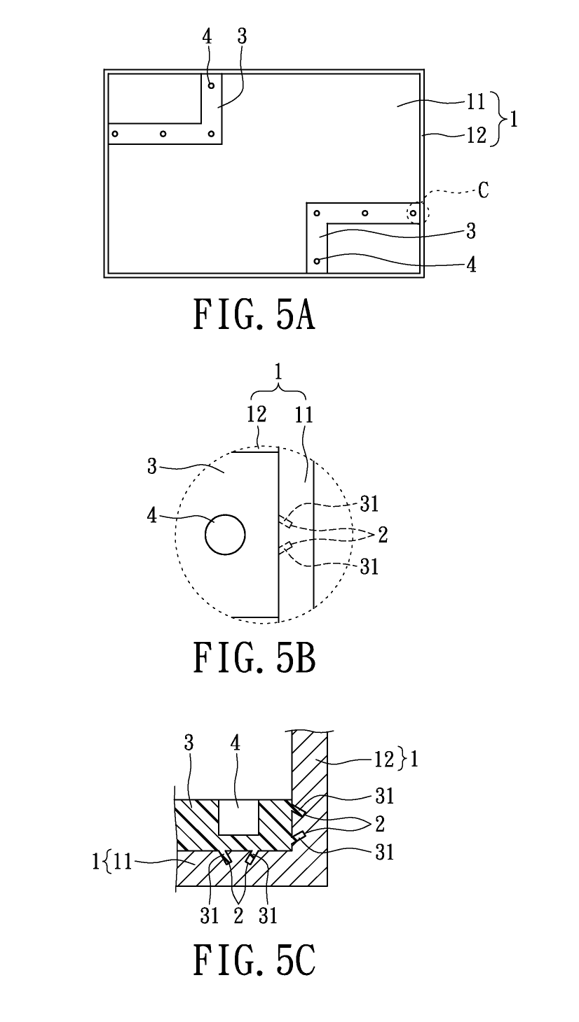

As shown in FIGS. 3A-3C, the metal substrate 1 originally is a smooth surface. The fixing grooves 2 are formed in a position desired to be manufactured of the metal substrate 1, by a drilling machine, a lathing machine, a punching machine, a milling machine or other machining equipments. The fixing grooves 2 extend into the metal substrate 1 from a surface of the metal substrate 1. In the cross-sectional view, the fixing grooves 2 and the surface of the metal substrate 1 form an oblique angle therebetween so that the plastic layers 3 can be fastened in the fixing grooves 2. As shown in FIGS. 4A-4C, according to desired appearances of products, the metal substrate 1 may include a bottom board 11 and at least one side board 12 which are formed by punching. The side board 12 is located on the periphery of the bottom board 11 and the bottom board 11 is perpendicular to the side board 12. The bottom board 11 and the side board 12 both have the fixing grooves 2. Further, as shown in FIGS. 5A-5C, in a mold-forming way, the plastic layers 3 are formed on the metal substrate 1 and the assembling holes 4 are formed in the plastic layers 3 and extend into the plastic layer 3 from a surface of the plastic layer 3. The plastic layers 3 and the assembling holes 4 may have an integrated structure formed by mold-forming.

The desired mold has a shape and structure according with the manufacturing demands. By injection molding or other forming ways, the molten plastic material is coated on the metal substrate 1 and filled in the fixing grooves 2. After the plastic material is solidified, the mold is removed and the plastic layers 3 are formed on the metal substrate 1. Based on the plastic material filled in the fixing grooves 2, each formed plastic layer 3 has at least one fastening portion 31, and the plastic layer 3 may be fastened in the fixing grooves 2 of the bottom board 1 or the fixing grooves 2 of the side board 12 via the fastening portion 31 and fixed on the metal substrate 1. Because the plastic layers 3 and all the assembling holes 4 may be formed in one piece directly via the mold, so there is no need for cutting a hole separately.

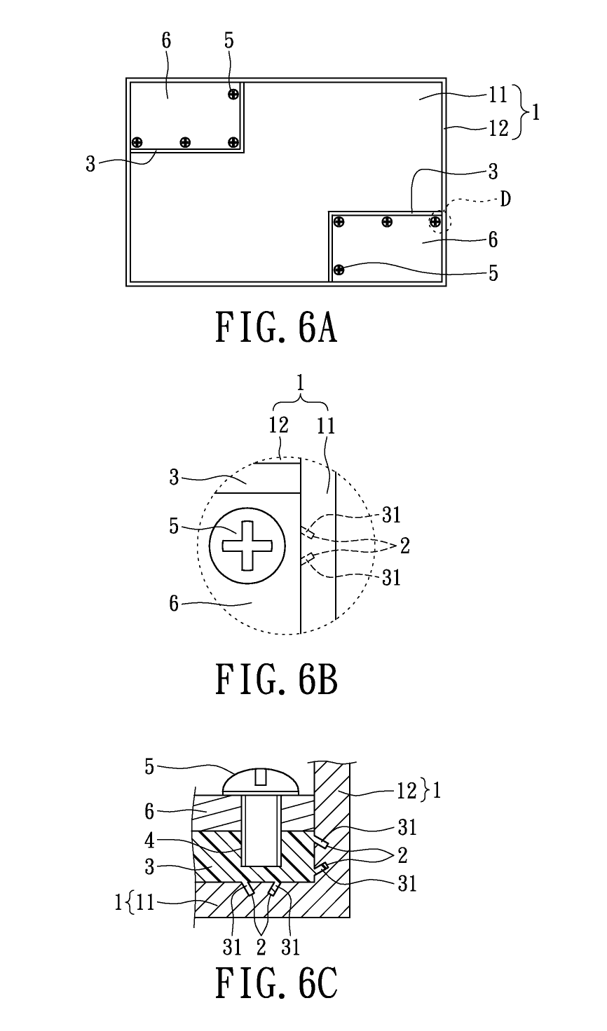

Any component may be disposed on the metal shell manufacturing structure easily, for example, motherboards, hard disks, power supplies, etc. As shown in FIGS. 6A-6C, at least one functional component 6 is assembled in the assembling holes 4 via at least one assembling device 5 so as to mount the functional component 6 on the metal shell manufacturing structure. The assembling holes 4 may be mold-formed to be screw holes, fastening holes or other kinds of assembling holes. The assembling devices 5 may be screws, tenons or other kinds of assembling devices.

In the metal shell manufacturing structure, the number, shapes and positions of the fixing grooves 2, the plastic layers 3 and the assembling holes 4 may be defined according to the configuration and arrangement of the functional components 6. The larger the number of fixing grooves 2 is, the more stably the plastic layer 3 is fixed on the metal substrate 1. Based on shapes of cutting tools and manufacturing modes of manufacturing devices, besides the circular shape in the embodiment, the plane shape of the fixing grooves may be other shapes, not limited herein. Additionally, the assembling holes 4 may also be formed by drilling, not limited in mold-forming.

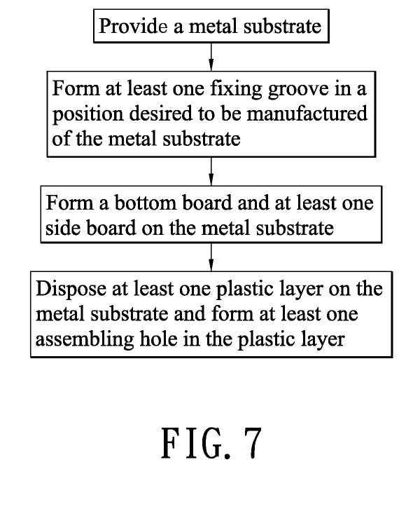

Accordingly, please refer to FIG. 7 simultaneously, the present invention provides a metal shell manufacturing method which includes the steps of:

(1). providing a metal substrate 1;

(2). as shown in FIGS. 3A-3C, forming at least one fixing groove 2 in the position desired to be manufactured of the metal substrate 1, by manufacturing devices, wherein the fixing groove 2 extends into the metal substrate 1 from the surface of the metal substrate 1, and the fixing groove 2 and the surface of the metal substrate 1 form an oblique angle therebetween to produce the effect of fastening and fixing;

(3). as shown in FIGS. 4A-4C, punching the metal substrate 1 according to the desired shape of a product to form a bottom board 11 and at least one side board 12 on the metal substrate 1, wherein the side board 12 is located on the periphery of the bottom board 11 and the bottom board 11 is perpendicular to the side board 12, the bottom board 11 and the side board 12 both have the fixing grooves 2;

(4). as shown in FIGS. 5A-5C, disposing at least one plastic layer 3 on the metal substrate 1 in a mold-forming way and forming at least one assembling hole 4 in the metal substrate 1, wherein the assembling hole 4 extends into the plastic layer 3 from the surface of the plastic layer 3, the plastic layer 3 and the assembling hole 4 have an integrated structure formed by mold-forming, the plastic layer 3 is fastened in the fixing groove 2 and fixed on the metal substrate 1, the plastic layer 3 and all the assembling holes 4 may be formed in one piece via a mold, without a hole being cut separately. The assembling hole 4 may be mold-formed to be screw holes, fastening holes or other kinds of assembling holes.

Furthermore, in the step (4), the assembling holes 4 may also be formed by drilling, not limited in mold-forming.

After the metal shell manufacturing method, as shown in FIGS. 6A-6C, at least one functional component 6 is assembled in the assembling holes 4 via at least one assembling device 5. The assembling devices 5 may be screws, tenons or other kinds of assembling devices.

Based on the above mentioned metal shell manufacturing structure and method of the present invention, the formed plastic layers 3 are fastened in the fixing grooves 2 directly and don't need to be fixed separately by welding, and the plastic layers 2 and all the assembling holes 4 may be formed in one piece via a mold, without a hole being cut separately. Accordingly, the manufacturing process is simplified, the costs are reduced, time is saved and the efficiency for manufacturing metal shells is maximized.

What are disclosed above are only the specification and the drawings of the preferred embodiments of the present invention and it is therefore not intended that the present invention be limited to the particular embodiments disclosed. It will be understood by those skilled in the art that various equivalent variations may be made depending on the specification and the drawings of the present invention without departing from the scope of the present invention.

What is claimed is:

1. A metal shell manufacturing structure, comprising:
a metal substrate;
at least one fixing groove, formed in the metal substrate and extending into the metal substrate from a surface of the metal substrate;
at least one plastic layer, disposed on the metal substrate and fastened in the fixing groove; and
at least one assembling hole, formed in the plastic layer and extending into the plastic layer from a surface of the plastic layer.

2. The metal shell manufacturing structure as claimed in claim 1, wherein the plastic layer is disposed on the metal substrate in a mold-forming way, and the plastic layer and the assembling hole have an integrated structure formed by mold-forming.

3. The metal shell manufacturing structure as claimed in claim 1, wherein the assembling hole is formed by drilling.

4. The metal shell manufacturing structure as claimed in claim 1, wherein the assembling hole is a screw hole or a fastening hole.

5. The metal shell manufacturing structure as claimed in claim 1, wherein the fixing groove and the surface of the metal substrate form an oblique angle therebetween.

6. The metal shell manufacturing structure as claimed in claim 1, wherein the metal substrate includes a bottom board and at least one side board located on the periphery of the bottom board.

7. The metal shell manufacturing structure as claimed in claim 6, wherein the bottom board and the side board both have the fixing groove.

8. A metal shell manufacturing method, comprising the steps of:
(1). providing a metal substrate;
(2). forming at least one fixing groove in the metal substrate, the fixing groove extending into the metal substrate from a surface of the metal substrate;
(3). forming a bottom board and at least one side board on the metal substrate, the side board located on a periphery of the bottom board; and
(4). disposing at least one plastic layer on the metal substrate, the plastic layer fastened in the fixing groove and fixed on the metal substrate; and forming at least one assembling hole in the plastic layer, the assembling hole extending into the plastic layer from a surface of the plastic layer.

9. The metal shell manufacturing method as claimed in claim 8, wherein in the step (2), the fixing groove and the surface of the metal substrate form an oblique angle therebetween.

10. The metal shell manufacturing method as claimed in claim 8, wherein in the step (3), the bottom board and the side board both have the fixing groove.

11. The metal shell manufacturing method as claimed in claim 8, wherein in the step (4), the plastic layer is disposed on the metal substrate in a mold-forming way, and the plastic layer and the assembling hole have an integrated structure formed by mold-forming.

12. The metal shell manufacturing method as claimed in claim 8, wherein in the step (4), the assembling hole is formed by drilling.

13. The metal shell manufacturing method as claimed in claim 8, wherein the assembling hole is a screw hole or a fastening hole.

14. The metal shell manufacturing method as claimed in claim 8, wherein in the step (4), at least one functional component is assembled in the assembling hole via at least one assembling device.

15. The metal shell manufacturing method as claimed in claim 14, wherein the assembling device is a screw or a tenon.
